(19) United States
(12) Patent Application Publication
(10) Pub. No.: US 2015/0253971 A1
(43) Pub. Date: Sep. 10, 2015

(54) ELECTRONIC APPARATUS AND DISPLAY CONTROL METHOD

(71) Applicant: KYOCERA Corporation, Kyoto-shi (JP)

(72) Inventor: Yoshinobu NAKAMURA, Kyotanabe-shi (JP)

(73) Assignee: KYOCERA Corporation

(21) Appl. No.: 14/722,047

(22) Filed: May 26, 2015

Related U.S. Application Data
(63) Continuation of application No. PCT/JP2013/081717, filed on Nov. 26, 2013.

(30) Foreign Application Priority Data
Nov. 28, 2012 (JP) 2012-259342

(51) Int. Cl. G06F 3/0484; G06T 3/40

(52) U.S. Cl. CPC G06F 3/04845; G06T 3/40

(57) ABSTRACT

An electronic apparatus comprises a display module configured to perform display in a display area, a line-of-sight detection module configured to detect a line of sight of a user to the display area, and a distance acquisition module configured to acquire a distance between the electronic apparatus and the user. The display module increases a display size of information in the display area when the distance changes while the line-of-sight detection module detects the line of sight.

### CROSS-REFERENCE TO RELATED APPLICATION

The present application is a continuation application of PCT Application No. PCT/JP2013/081717, filed on Nov. 26, 2013, which claims the benefit of Japanese Patent Application No. 2012-259342, filed on Nov. 28, 2012. The contents of these applications are incorporated herein by reference in their entirety.

### FIELD

Embodiments of the present disclosure relate to display control in an electronic apparatus.

### BACKGROUND

Various techniques have been proposed for an electronic apparatus comprising a display function.

### SUMMARY

An electronic apparatus, a recording medium and a display control method are disclosed. In one embodiment, an electronic apparatus comprises a display module configured to perform display in a display area, a line-of-sight detection module configured to detect a line of sight of a user to the display area, and a distance acquisition module configured to acquire a distance between the electronic apparatus and the user. The display module increases a display size of information in the display area when the distance changes while the line-of-sight detection module detects the line of sight.

In one embodiment, an electronic apparatus comprises a display module configured to perform display in a display area, a line-of-sight detection module configured to detect a line of sight of a user to the display area, and an acceleration acquisition module configured to acquire acceleration of the electronic apparatus. The display module increases a display size of information in the display area when the acceleration changes while the line-of-sight detection module detects the line of sight.

In one embodiment, a non-transitory recording medium readable by a computer stores a control program that controls an electronic apparatus comprising a display area. The control program is configured to cause the electronic apparatus to perform the steps of (a) detecting a line of sight of a user to the display area, (b) acquiring a distance between the electronic apparatus and the user or acceleration of the electronic apparatus, and (c) increasing a display size of information in the display area when the distance or the acceleration changes while the line of sight is detected.

In one embodiment, a display control method for use in an electronic apparatus comprising a display area comprises the steps of (a) detecting a line of sight of a user to the display area, (b) acquiring a distance between the electronic apparatus and the user or acceleration of the electronic apparatus, and (c) increasing a display size of information in the display area when the distance or the acceleration changes while the line of sight is detected.

### BRIEF DESCRIPTION OF DRAWINGS

FIG. 1 illustrates a front view showing appearance of an electronic apparatus.

FIG. 2 illustrates a rear view showing appearance of the electronic apparatus.

FIG. 3 illustrates electrical components of the electronic apparatus.

FIG. 4 illustrates a plurality of functional blocks of a controller.

FIG. 5 illustrates a flow chart showing operation of the electronic apparatus.

FIG. 6 illustrates some components of an electronic apparatus according to a modification.

FIG. 7 illustrates a flow chart showing operation of an electronic apparatus according to a modification.

### DETAILED DESCRIPTION

<Appearance of Electronic Apparatus>

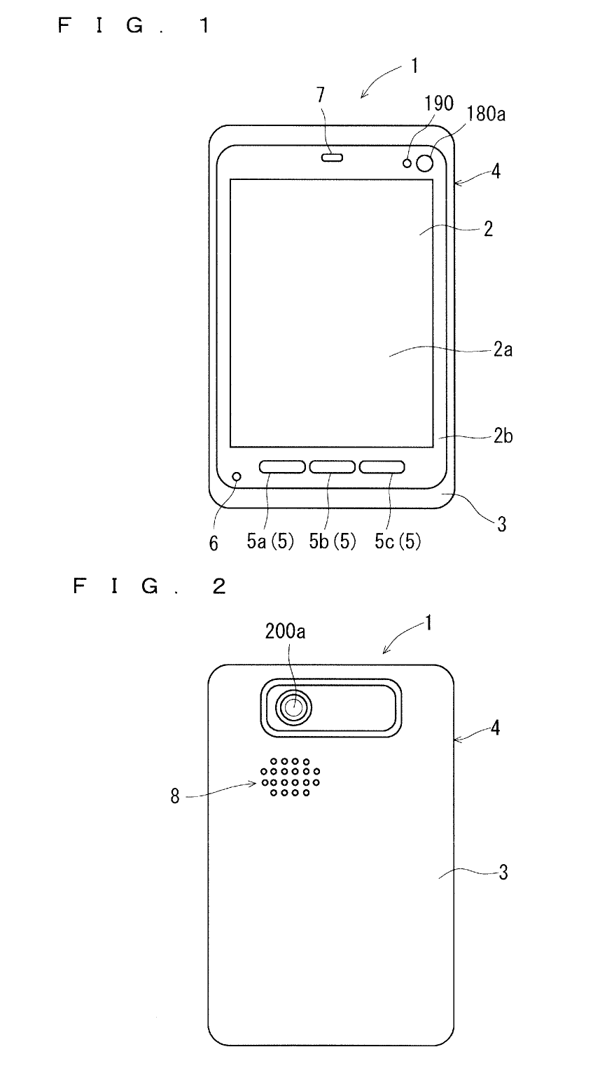

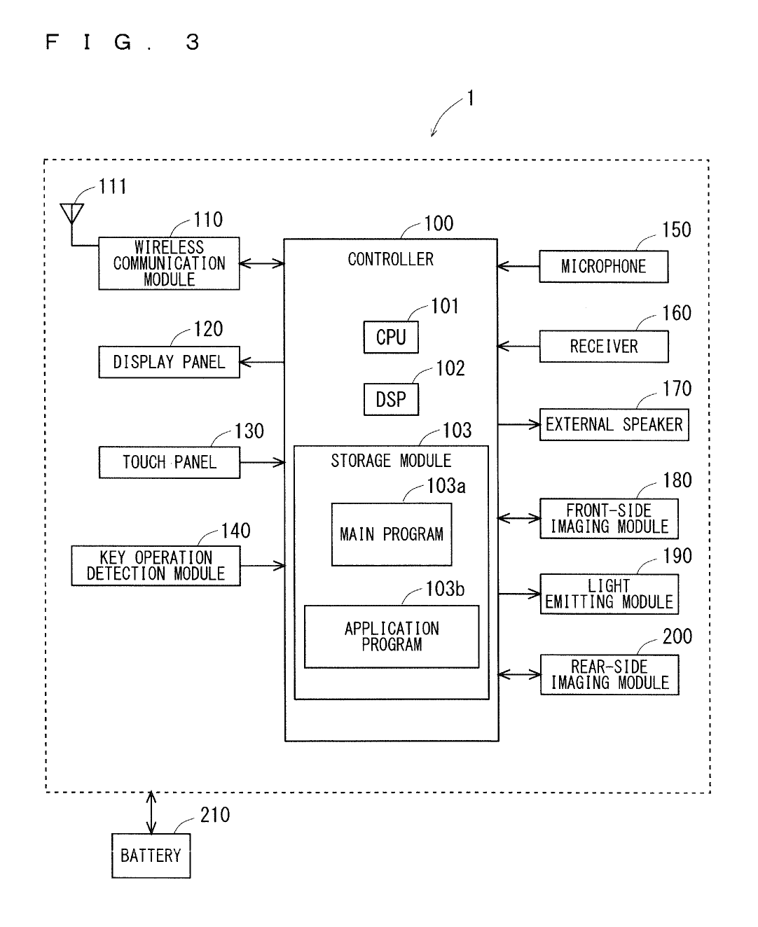

FIGS. 1 and 2 respectively illustrate a front view and a rear view showing appearance of an electronic apparatus 1 according to one embodiment. The electronic apparatus 1 according to one embodiment is, for example, a mobile phone, and can communicate with another communication apparatus through a base station and a server or the like. As illustrated in FIGS. 1 and 2, the electronic apparatus 1 includes a cover panel 2 and a case part 3. The cover panel 2 and the case part 3 have been combined to constitute an apparatus case 4 having an approximately rectangular plate-like shape in a plan view.

The cover panel 2 is approximately rectangular in a plan view. The cover panel 2 forms a portion of the front of the electronic apparatus 1 other than the periphery. The cover panel 2 is made, for example, of transparent glass or transparent acrylic resin. The case part 3 includes the periphery of the front of the electronic apparatus 1, the side of the electronic apparatus 1 and the rear of the electronic apparatus 1. The case part 3 is made, for example, of polycarbonate resin.

The cover panel 2 has, on its front surface, a display area 2a in which various information pieces, such as characters, symbols, and graphics, are displayed. The display area 2a is, for example, rectangular in a plan view. A periphery 2b, of the cover panel 2, surrounding the display area 2a is black, as a film or the like is stuck on the periphery 2b. Hence, the periphery 2b is a non-display portion in which no information is displayed. A touch panel 130, which is described later, is stuck on a rear surface of the cover panel 2. This allows a user to provide various instructions to the electronic apparatus 1 by operating the display area 2a on the front of the electric apparatus 1 with a finger and the like. The user can also provide various instructions to the electronic apparatus 1 by operating the display area 2a with an operator other than a finger, such as a pen for a capacitive touch panel including a stylus pen.

A home key 5a, a menu key 5b, and a back key 5c are provided in the apparatus case 4. The home key 5a, the menu key 5b, and the back key 5c are each a hardware key. Surfaces of the home key 5a, the menu key 5b, and the back key 5c are each exposed in a lower end of the front surface of the cover panel 2. The home key 5a is an operation key for displaying a home screen (initial screen) in the display area 2a. The menu key 5b is an operation key for displaying an option menu screen. The back key 5c is an operation key for returning a screen in the display area 2a to a previous screen.

The home key 5a, the menu key 5b, and the back key 5c are hereinafter each referred to as an “operation key 5” when there is no particular need to distinguish among them. Each of the home key 5a, the menu key 5b, and the back key 5c may not be a hardware key but may be a software key which is displayed in the display area 2a, and operation for which is detected by the touch panel 130.

The cover panel 2 has a microphone hole 6 in its lower end. The cover panel 2 has a receiver hole 7 in its upper end. From the upper end of the front surface of the cover panel 2, an imaging lens 180a of a front-side imaging module 180, which is described later, and a light emitting module 190, which is described later, are visible. As illustrated in FIG. 2, the electronic apparatus 1 has speaker holes 8 on its rear, in other words, on the rear of the apparatus case 4. From the rear of the electronic apparatus 1, an imaging lens 200a of a rear-side imaging module 200, which is described later, is visible.

<Electrical Components of Electronic Apparatus>

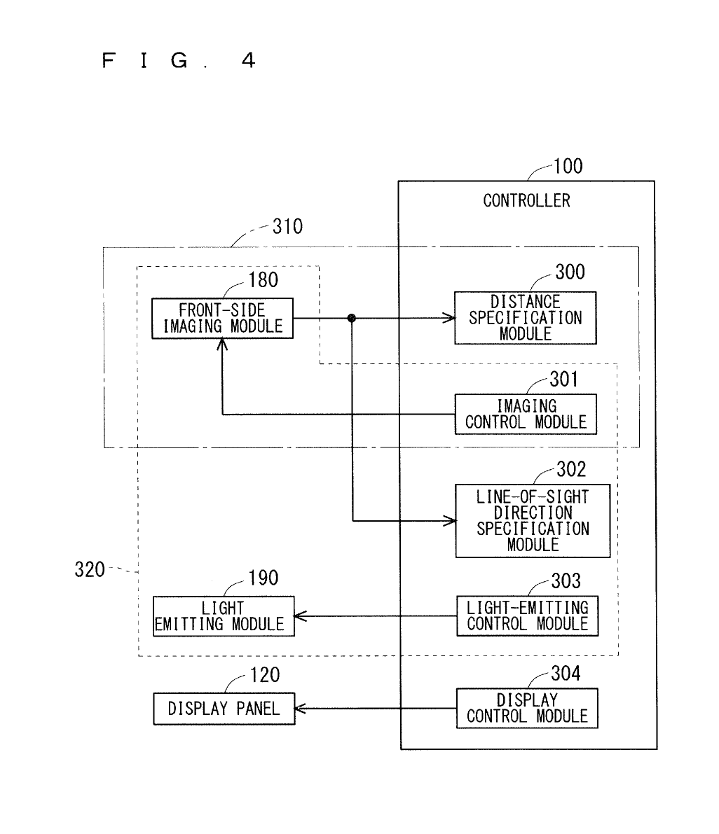

FIG. 3 illustrates a block diagram showing electrical components of the electronic apparatus 1. As illustrated in FIG. 3, the electronic apparatus 1 includes a controller 100, a wireless communication module 110, a display panel 120, the touch panel 130, and a key operation detection module 140. The electronic apparatus 1 further includes a microphone 150, a receiver 160, an external speaker 170, the front-side imaging module 180, the light emitting module 190, the rear-side imaging module 200, and a battery 210. These components of the electronic apparatus 1 are housed in the apparatus case 4.

The controller 100 includes a central processing unit (CPU) 101, a digital signal processor (DSP) 102, a storage module 103 and the like. The controller 100 can perform overall management of operation of the electronic apparatus 1 by controlling the other components of the electronic apparatus 1.

The storage module 103 is configured as a non-transitory recording medium, such as read only memory (ROM) and random access memory (RAM), readable by the controller 100 (the CPU 101 and the DSP 102). The storage module 103 can store therein a main program 103a, a plurality of application programs 103b, and the like. The main program 103a is a control program for controlling operation of the electronic apparatus 1, specifically, the components, such as the wireless communication module 110 and the display panel 120, of the electronic apparatus 1. The CPU 101 and the DSP 102 execute various programs stored in the storage module 103 to achieve various functions of the controller 100. FIG. 3 illustrates only a single application program 103b to avoid complexity in the drawing.

The storage module 103 may include a computer-readable non-transitory recording medium other than the ROM and the RAM. The storage module 103 may include a small hard disk drive, solid state drive (SSD), and the like, for example.

The wireless communication module 110 has an antenna 111. The wireless communication module 110 can receive, through use of the antenna 111, a signal from a mobile phone other than the electronic apparatus 1 or a communication apparatus, such as a web server, connected to the Internet through a base station and the like. The wireless communication module 110 can amplify and down-convert the received signal, and output the resulting received signal to the controller 100. The controller 100 can, for example, demodulate the received signal as input to obtain a sound signal indicating sound, music, and the like included in the received signal. The wireless communication module 110 can also up-convert and amplify a transmitted signal that is generated by the controller 100 and includes the sound signal and the like, and then wirelessly transmit the resulting transmitted signal from the antenna 111. The transmitted signal from the antenna 111 is received by the mobile phone other than the electronic apparatus 1 or the communication apparatus connected to the Internet through the base station and the like.

The display panel 120 is, for example, a liquid crystal display panel or an organic EL panel. The display panel 120 is controlled by the controller 100 so as to display various information pieces, such as characters, symbols, and graphics. Information displayed by the display panel 120 is displayed in the display area 2a on the front surface of the cover panel 2. Therefore, it can be said that the display panel 120 performs display in the display area 2a.

The touch panel 130 can detect operation performed with an operator, such as a finger, in the display area 2a of the cover panel 2. The touch panel 130 is, for example, a projected capacitive touch panel, and is stuck on the rear surface of the cover panel 2. When a user performs operation in the display area 2a of the cover panel 2 with an operator, such as a finger, a signal corresponding to the operation is input from the touch panel 130 to the controller 100. The controller 100 specifies contents of the operation performed in the display area 2a based on the signal input from the touch panel 130, and performs processing in accordance with the contents.

The key operation detection module 140 can detect user's operation of pressing each operation key 5. The key operation detection module 140 can detect, for each operation key 5, whether the operation key 5 is pressed (operated) or not. When the operation key 5 is not pressed, the key operation detection module 140 can output, to the controller 100, a non-operation signal indicating that the operation key 5 is not operated. When the operation key 5 is pressed, the key operation detection module 140 can output, to the controller 100, an operation signal indicating that the operation key 5 is operated. As such, the controller 100 can determine, for each operation key 5, whether the operation key 5 is operated or not.

When the key operation detection module 140 detects pressing and then releasing of the home key 5a, the controller 100 causes the display panel 120 to display the home screen (initial screen). As a result, the home screen is displayed in the display area 2a. When the key operation detection module 140 detects pressing and then releasing of the menu key 5b, the controller 100 causes the display panel 120 to display the option menu screen. As a result, the option menu screen is displayed in the display area 2a. When the key operation detection module 140 detects pressing and then releasing of the back key 5c, the controller 100 causes the display panel 120 to return a screen to a previous screen. As a result, a screen in the display area 2a is returned to a previous screen.

The microphone 150 can convert sound input from outside the electronic apparatus 1 into an electrical sound signal, and output the electrical sound signal to the controller 100. The sound input from outside the electronic apparatus 1 is taken into the electronic apparatus 1 through the microphone hole 6 in the front surface of the cover panel 2, and input into the microphone 150.

The external speaker 170 is, for example, a dynamic speaker. The external speaker 170 can convert the electrical sound signal from the controller 100 into sound, and output the sound. The sound output from the external speaker 170 is output to the outside through the speaker holes 8 in the rear of the electronic apparatus 1. The sound output from the speaker holes 8 can be heard even in a place remote from the electronic apparatus 1.

The front-side imaging module 180 includes the imaging lens 180a, an imaging device and the like. The front-side imaging module 180 can capture a still image and a moving image based on control performed by the controller 100. The front-side imaging module 180 may be an infrared-ray imaging module, and captures a monochrome image. Since the imaging lens 180a is provided on the front of the electronic apparatus 1 as illustrated in FIG. 1, the front-side imaging module 180 can capture an image of an object existing in the front side (the cover panel 2 side) of the electronic apparatus 1.

The light emitting module 190 can emit infrared rays. The light emitting module 190 is configured, for example, as an infrared-ray light emitting diode (LED). Since the light emitting module 190 is exposed in the front of the electronic apparatus 1 as illustrated in FIG. 1, the light emitting module 190 emits infrared rays towards the front side (the cover panel 2 side) of the electronic apparatus 1.

The rear-side imaging module 200 includes the imaging lens 200a, an imaging device and the like. The rear-side imaging module 200 can capture a still image and a moving image based on control performed by the controller 100. The rear-side imaging module 200 may be a visible-light imaging module, and captures a color image. Since the imaging lens 200a is provided on the rear of the electronic apparatus 1 as illustrated in FIG. 2, the rear-side imaging module 200 can capture an image of an object existing in the rear side of the electronic apparatus 1.

The receiver 160 can output received sound, and is configured, for example, as a dynamic speaker. The receiver 160 can convert the electrical sound signal from the controller 100 into sound, and output the sound. The sound output from the receiver 160 is output to the outside through the receiver hole 7 provided in the front of the electronic apparatus 1. The volume of the sound output through the receiver hole 7 is smaller than the volume of the sound output through the speaker holes 8.

The battery 210 can output power supply for the electronic apparatus 1. The power supply output from the battery 210 is supplied to electronic components included in the controller 100, the wireless communication module 110, and the like of the electronic apparatus 1.

The storage module 103 stores therein the various application programs 103b (hereinafter, simply referred to as the “applications 103b”). For example, the storage module 103 stores therein a telephone application for performing communication by use of a telephone function, a browser for displaying web sites, and a mail application for creating, viewing, and transmitting/receiving emails. The storage module 103 also may store therein a television application for watching and recording television programs, a moving image playback control application for performing playback control of moving image data stored in the storage module 103, a music playback control application for performing playback control of music data stored in the storage module 103, and the like.

When the controller 100 reads and executes one of the applications 103b stored in the storage module 103 during execution of the main program 103a stored in the storage module 103, the controller 100 controls the other components of the electronic apparatus 1, such as the wireless communication module 110, the display panel 120, and the receiver 160, so that the function (processing) corresponding to the application 103b is achieved by the electronic apparatus 1. For example, the controller 100 controls the wireless communication module 110, the microphone 150, and the receiver 160 during execution of the telephone application. As a result, in the electronic apparatus 1, sound included in the received signal received by the wireless communication module 110 is output from the receiver 160, and the transmitted signal including sound input into the microphone 150 is transmitted from the wireless communication module 110. That is to say, in the electronic apparatus 1, communication using the telephone function is performed with a communication partner apparatus.

<Functional Blocks of Control Module>

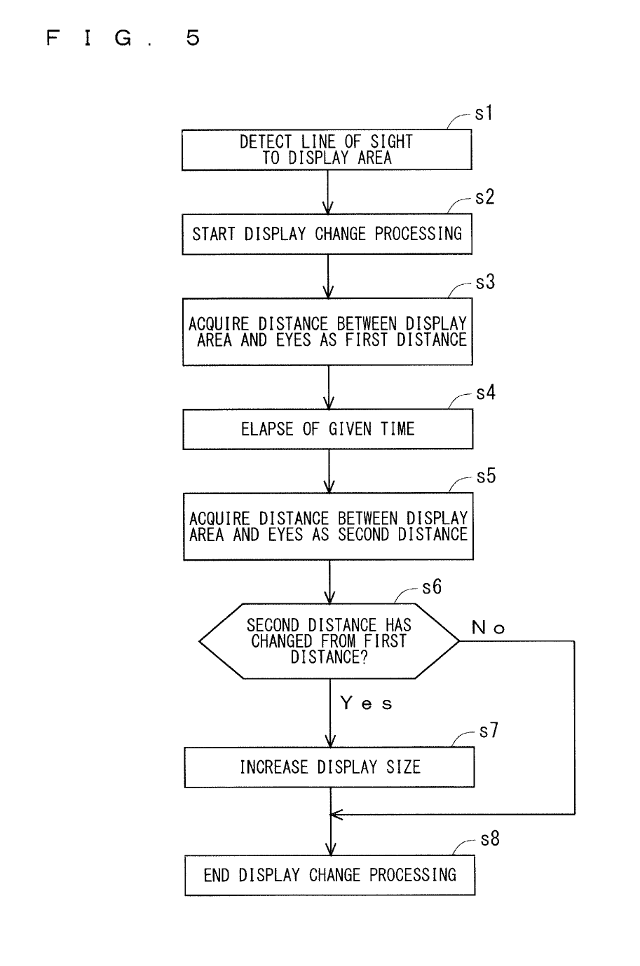

The controller 100 executes the main program 103a. The controller 100 includes a plurality of functional blocks. FIG. 4 illustrates some of the functional blocks formed by the controller 100.

As illustrated in FIG. 4, the controller 100 includes, as the functional blocks, a distance specification module 300, an imaging control module 301, a line-of-sight direction specification module 302, a light-emitting control module 303, and a display control module 304.

The imaging control module 301 can control the front-side imaging module 180 to cause the front-side imaging module 180 to capture an image. The imaging control module 301 can also control the rear-side imaging module 200 to cause the rear-side imaging module 200 to capture an image. The light-emitting control module 303 can control the light emitting module 190 to cause the light emitting module 190 to emit infrared rays. The display control module 304 can control the display panel 120 to control display on the display panel 120, i.e., display in the display area 2a.

In one embodiment, the distance specification module 300, the imaging control module 301, and the front-side imaging module 180 constitute a distance acquisition module 310 that can acquire the distance between the electronic apparatus 1 and a user. In the distance acquisition module 310, the distance specification module 300 specifies the distance between the electronic apparatus 1 and the user, specifically, the distance between the display area 2a and the user's eyes on the basis of an image captured by the front-side imaging module 180 controlled by the imaging control module 301. The distance specification module 300 can specify the distance between the display area 2a and the user's eyes based on the image captured by the front-side imaging module 180 as in the technique disclosed in Japanese Patent Application Laid-Open Publication No. 2003-75717, for example. Specifically, the distance specification module 300 specifies a face image of the user from the image captured by the front-side imaging module 180. The distance specification module 300 acquires a size of the specified face image of the user, and then acquires the distance between the user's face and the electronic apparatus 1 from the acquired size. The distance specification module 300 uses the acquired distance as the distance between the user's eyes and the display area 2a provided on the front of the electronic apparatus 1. The electronic apparatus 1 may acquire the distance between the display area 2a and the user's eyes by another method.

In one embodiment, the line-of-sight direction specification module 302, the imaging control module 301, the light-emitting control module 303, the front-side imaging module 180, and the light emitting module 190 constitute a line-of-sight detection module 320 that can detect a line of sight of a user to the display area 2a. Processing performed by the line-of-sight detection module 320 to detect the line of sight of the user to the display area 2a is hereinafter referred to as “line-of-sight detection processing”.

The line-of-sight detection module 320 performs the line-of-sight detection processing as in the technique disclosed in Japanese Patent Application Laid-Open Publication No. 2007-29712, for example. Specifically, when the line-of-sight detection module 320 performs the line-of-sight detection processing, the light emitting module 190 first emits infrared rays through control performed by the light-emitting control module 303. In a state in which the light emitting module 190 emits the infrared rays, the front-side imaging module 180 captures an image through control performed by the imaging control module 301. In this case, the front-side imaging module 180 captures an image of a face of a user illuminated with the infrared rays emitted by the light emitting module 190 when the user views a screen in the display area 2a. The line-of-sight direction specification module 302 specifies a direction of a line of sight of the user based on the image captured by the front-side imaging module 180. Specifically, the line-of-sight direction specification module 302 specifies, from the image captured by the front-side imaging module 180, the pupils of the user's eyes and Purkinje images that are reflections of the infrared rays on surfaces of the corneas (ocular surfaces) of the user's eyes. In this case, the line-of-sight detection module 320 detects no line of sight of the user to the display area 2a when the user does not view the display in the display area 2a, and thus the line-of-sight direction specification module 302 cannot specify the pupils and the Purkinje images from the image captured by the front-side imaging module 180.

When the pupils and the Purkinje images are specified, the line-of-sight direction specification module 302 specifies the direction of the line of sight of the user based on the center positions of the pupils and the center positions of the Purkinje images. The line-of-sight direction specification module 302 then determines whether the line of sight of the user is in the display area 2a based on the specified direction of the line of sight. When the line-of-sight direction specification module 302 determines that the line of sight of the user is in the display area 2a, the line-of-sight detection module 320 detects the line of sight of the user to the display area 2a. When the line-of-sight direction specification module 302 determines that the line of sight of the user is not in the display area 2a, the line-of-sight detection module 320 detects no line of sight of the user to the display area 2a.

As described above, the line-of-sight detection module 320 detects the line of sight of the user to the display area 2a when the user views display in the display area 2a.

When the display in the display area 2a is OFF, and thus no information is displayed in the display area 2a, the line-of-sight detection module 320 does not perform the line-of-sight detection processing. The electronic apparatus 1 may detect the line of sight of the user to the display area 2a by another method.

<Display Size Increase Processing>

For example, middle-aged and elderly people may have difficulty viewing information, such as characters, displayed in the display area 2a immediately after they come to view the display area 2a. In such a case, the middle-aged and elderly people may increase the distance between the display area 2a and their eyes by moving their heads so that their eyes are moved away from the display area 2a or by moving the electronic apparatus 1 so that the display area 2a is moved away from their eyes after they come to view the display area 2a.

On the other hands, people with myopia may decrease the distance between the display area 2a and their eyes by moving their heads so that their eyes are moved close to the display area 2a or by moving the electronic apparatus 1 so that the display area 2a is moved close to their eyes when the display size of information, such as characters, in the display area 2a is so small that they have difficulty viewing the information.

As described above, users may change the distance between the display area 2a and their eyes when they have difficulty viewing information displayed in the display area 2a.

The electronic apparatus 1 according to one embodiment increases the display size of the information in the display area 2a when the distance between the display area 2a and the eyes of a user changes while detecting a line of sight of the user. This allows the middle-aged and elderly people, the people with myopia, and the like to easily view the display in the display region 2a. Visibility of display of the electronic apparatus 1 is thus improved. Details on this point are described below.

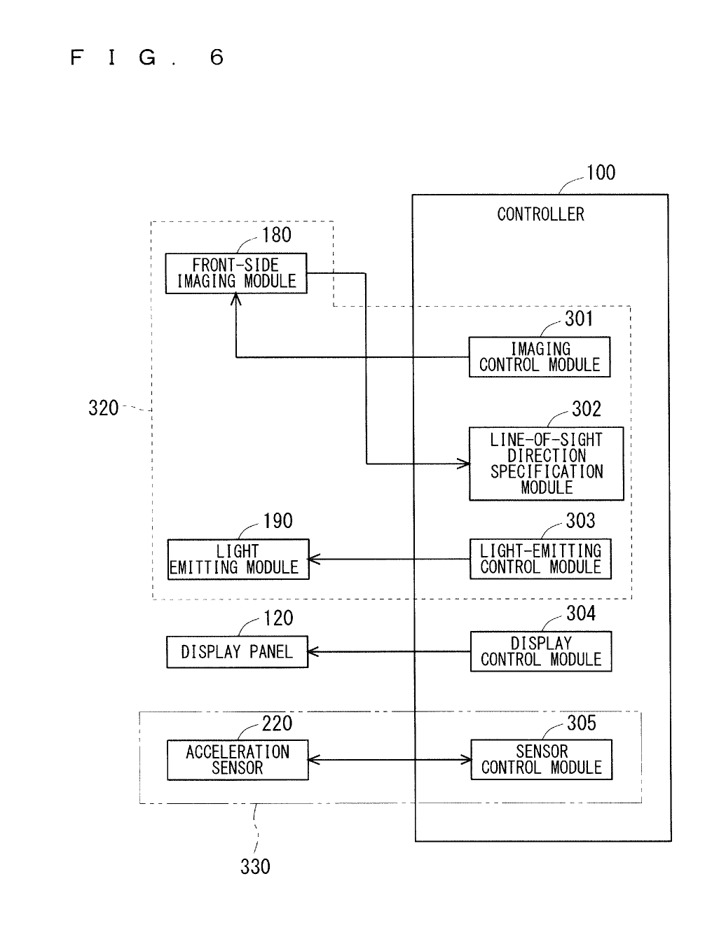

FIG. 5 illustrates a flow chart showing operation of the electronic apparatus 1. In one embodiment, the line-of-sight detection module 320 performs the above-mentioned line-of-sight detection processing on a regular basis, e.g., every several hundred milliseconds, when the display in the display area 2a is ON.

As illustrated in FIG. 5, when a user who has not viewed the display in the display area 2a comes to view the display in the display area 2a, and thus the line-of-sight detection module 320 comes to detect a line of sight of the user to the display area 2a in a step s1, the electronic apparatus 1 starts display change processing in a step s2.

Upon the start of the display change processing, the distance acquisition module 310 acquires, as a first distance, the distance between the display area 2a and the eyes of the user as described above in a step s3. As a result, the distance between the display area 2a and the eyes of the user immediately after the user comes to view the display in the display area 2a is acquired as the first distance.

When a given time (e.g., two seconds) has elapsed since the acquisition of the first distance (step s4), the distance acquisition module 310 acquires, as a second distance, the distance between the display area 2a and the eyes of the user in a step s5. As a result, the distance between the display area 2a and the eyes of the user some time after the user comes to view the display in the display area 2a is acquired as the second distance.

Next, the distance specification module 300 of the distance acquisition module 310 determines whether the second distance has changed from the first distance in a step s6. Specifically, the distance specification module 300 determines whether the second distance has changed from the first distance by a predetermined value (e.g., 10 cm) or more. The distance specification module 300 calculates the absolute value of the difference between the first distance and the second distance, and determines that the second distance has changed from the first distance by the predetermined value (e.g., 10 cm) or more when the absolute value is equal to or more than the predetermined value. The distance specification module 300 determines that the second distance has not changed from the first distance by the predetermined value or more when the absolute value of the difference between the first distance and the second distance is less than the predetermined value.

When it is determined that the second distance has changed from the first distance by the predetermined value or more in the step s6, the display panel 120 increases the display size of the information, such as characters and icons, in the display area 2a through control performed by the display control module 304 in a step s7. For example, the display panel 120 doubles the display size of the information, such as characters, in the display area 2a. When the step s7 is performed, the electronic apparatus 1 ends the display change processing in a step s8. When it is determined that the second distance has not changed from the first distance by the predetermined value or more in the step s6, the step s8 is performed without changing the display size of the information in the display area 2a to end the display change processing.

The display change processing as described above is performed only while the line-of-sight detection module 320 detects the line of sight of the user to the display area 2a. Therefore, when the line-of-sight detection module 320, which performs the line-of-sight detection processing on a regular basis, no longer detects the line of sight of the user to the display area 2a after the start of the display change processing (after the step s2) and before the end of the display change processing (before the step s8), the display change processing is forced to end. In this case, if the display size of the information in the display area 2a has been increased, the display panel 120 returns the display size of the information in the display area 2a to an original size. When the line-of-sight detection module 320 comes to detect the line of sight of the user to the display area 2a again (step s1), the step s2 is performed, and the electronic apparatus 1 thereafter operates in a similar manner.

When the line-of-sight detection module 320 no longer detects the line of sight of the user to the display area 2a after the step s8, the display panel 120 returns the display size of the information in the display area 2a to the original size. When the line-of-sight detection module 320 comes to detect the line of sight of the user to the display area 2a again (step s1), the step s2 is performed, and the electronic apparatus 1 thereafter operates in a similar manner.

As described above, in one embodiment, after increasing the display size of the information in the display area 2a, the display panel 120 returns the display size to the original size when the line-of-sight detection module 320 no longer detects the line of sight of the user to the display area 2a.

As described so far, in the electronic apparatus 1 according to one embodiment, the display panel 120 increases the display size of the information in the display area 2a when the distance between the electronic apparatus 1 and the user acquired by the distance acquisition module 310 changes while the line-of-sight detection module 320 detects the line of sight of the user to the display area 2a. The display size of the information in the display area 2a can thus be increased when the middle-aged and elderly people increase the distance between the display area 2a and their eyes after viewing the display in the display area 2a. This allows the middle-aged and elderly people to easily view the display in the display region 2a. The display size of the information in the display area 2a can be increased when the people with myopia decrease the distance between the display area 2a and their eyes. This also allows the people with myopia to easily view the display in the display area 2a. Visibility of display of the electronic apparatus 1 is thus improved.

<Various Modifications>

The following describes various modifications of the electronic apparatus 1 according to one embodiment.

<First Modification>

In the display change processing in above-mentioned one example, the distance between the electronic apparatus 1 and the user's eyes is acquired only twice, i.e., immediately after the line-of-sight detection module 320 comes to detect the line of sight of the user to the display area 2a, and when a given time has elapsed since the detection. In the display change processing, however, the distance acquisition module 310 may repeatedly acquire the distance between the electronic apparatus 1 and the user's eyes. That is to say, the distance acquisition module 310 may repeatedly acquire the distance between the display area 2a and the user's eyes while the line-of-sight detection module 320 detects the user's line of sight to the display area 2a. For example, the distance acquisition module 310 may repeatedly acquire the distance between the display area 2a and the user's eyes every second while the line-of-sight detection module 320 detects the user's line of sight to the display area 2a. In such a case, after acquiring the distance between the display area 2a and the user's eyes, the distance acquisition module 310 determines whether the acquired distance has changed from the distance between the display area 2a and the user's eyes acquired immediately before the acquisition. Specifically, the distance acquisition module 310 determines whether the acquired distance has changed from the distance acquired immediately before the acquisition by a predetermined value (e.g., 10 cm) or more. When the distance acquisition module 310 determines that the acquired distance has changed from the distance acquired immediately before the acquisition by the predetermined value or more, the display panel 120 increases the display size of the information in the display area 2a. The display change processing then ends.

When the distance acquisition module 310 determines that the acquired distance has not changed from the distance acquired immediately before the acquisition by the predetermined value or more, the display panel 120 maintains the current display size without increasing the display size of the information in the display area 2a. In this case, the distance acquisition module 310 determines whether the distance acquired next has changed from the distance acquired immediately before the acquisition by the predetermined value or more without ending the display change processing. The electronic apparatus 1 then operates in a similar manner while the line-of-sight detection module 320 detects the user's line of sight to the display area 2a.

As described above, in the first modification, the distance acquisition module 310 repeatedly acquires the distance between the electronic apparatus 1 and the user's eyes while the line-of-sight detection module 320 detects the user's line of sight to the display area 2a. The display panel 120 increases the display size of the information in the display area 2a when the distance acquired by the distance acquisition module 310 has changed from the distance acquired by the distance acquisition module 310 immediately before the acquisition. The display size of the information in the display area 2a can be increased not only when the user changes the distance between the display area 2a and the eyes immediately after the user comes to view the display in the display area 2a but also when the user changes the distance between the display area 2a and the eyes some time after the user comes to view the display in the display area 2a. Visibility of display of the electronic apparatus 1 is thus further improved.

As long as the line-of-sight detection module 320 detects the user's line of sight to the display area 2a, the display change processing may not end even when the display size of the information in the display area 2a is increased. In this case, while the line-of-sight detection module 320 detects the user's line of sight to the display area 2a, the distance acquisition module 310 determines whether the distance newly acquired has changed from the distance acquired immediately before the acquisition by the predetermined value or more even when the display size of the information in the display area 2a is increased. When the distance acquisition module 310 determines that the distance newly acquired has changed from the distance acquired immediately before the acquisition by the predetermined value or more, the display panel 120 further increases the display size of the information in the display area 2a. As a result, while the line-of-sight detection module 320 detects the user's line of sight to the display area 2a, the display size of the information in the display area 2a is increased each time the distance between the display area 2a and the user's eyes changes.

<Second Modification>

In above-mentioned one example, the display change processing is performed when the line-of-sight detection module 320 comes to detect the user's line of sight to the display area 2a. In addition to or in place of such timing, the display change processing may be performed when a display screen in the display area 2a changes while the line-of-sight detection module 320 detects the user's line of sight to the display area 2a. The following describes operation of the electronic apparatus 1 according to the second modification.

In the electronic apparatus 1 according to one modification, the step s2 is performed to start the display change processing when the display screen displayed in the display area 2a changes while the line-of-sight detection module 320 detects the user's line of sight to the display area 2a. The step s3 is then performed to acquire, as the first distance, the distance between the display area 2a and the user's eyes. As a result, the distance between the display area 2a and the user's eyes immediately after the display screen displayed in the display area 2a is switched to another display screen while the user views the display in the display area 2a is acquired as the first distance.

When a given time (e.g., two seconds) has elapsed since the acquisition of the first distance (step s4), the step s5 is performed to acquire, as the second distance, the distance between the display area 2a and the user's eyes. As a result, the distance between the display area 2a and the user's eyes some time after the display screen displayed in the display area 2a is switched to the other display screen while the user views the display in the display area 2a is acquired as the second distance.

Next, the step s6 is performed, so that the distance acquisition module 310 determines whether the second distance has changed from the first distance. When it is determined that the second distance has changed from the first distance in the step s6, the above-mentioned step s7 is performed, so that the display panel 120 increases the display size of the information in the display area 2a. The step s8 is then performed, so that the electronic apparatus 1 ends the display change processing. When it is determined that the second distance has not changed from the first distance in the step s6, the step s8 is performed without changing the display size of the information in the display area 2a, and the display change processing ends. When the line-of-sight detection module 320 no longer detects the line of sight of the user to the display area 2a while the display change processing is performed, the display change processing is forced to end as in above-mentioned one example.

As described above, in the electronic apparatus 1 according to the second modification, the distance acquisition module 310 acquires, as the first distance, the distance between the electronic apparatus 1 and the user when the display screen in the display area 2a changes while the line-of-sight detection module 320 detects the user's line of sight to the display area 2a, and acquires the distance as the second distance when the given time has elapsed since the acquisition of the first distance. When the second distance acquired by the distance acquisition module 310 has changed from the first distance acquired by the distance acquisition module 310, the display panel 120 increases the display size of the information in the display area 2a. Therefore, when the user has difficulty viewing the display in the display area 2a due to the change of the display screen in the display area 2a, and changes the distance between the eyes and the display area 2a, the display size of the information in the display area 2a can be increased.

As a specific example, when a web page displayed in the display area 2a is switched to a web page including small characters and the like while the controller 100 runs a browser, the user may decrease the distance between the eyes and the display area 2a. In such a case, the electronic apparatus 1 according to the second modification can increase the display size of the information, such as characters, included in the web page displayed in the display area 2a. This allows the user to easily view the web page newly displayed.

The user may also decrease the distance between the eyes and the display area 2a when the display screen in the display area 2a is switched, for example, to an incoming mail browsing screen upon start of execution of a mail application by the controller 100, and the size of characters, graphics, and the like included in the browsing screen is small. In such a case, the electronic apparatus 1 according to the second modification can increase the display size of the characters, graphics, and the like included in the browsing screen displayed in the display area 2a. This allows the user to easily view incoming mails included in the browsing screen.

The display change processing may be performed each time the display screen in the display area 2a changes while the line-of-sight detection module 320 detects the user's line of sight to the display area 2a.

<Third Modification>

Objects may sometimes look yellowish to the middle-aged and elderly people due to their aged vision. In such a case, an object is easily viewed when the difference between the brightness of the object and the brightness of the background is large.

In the electronic apparatus 1 according to the third modification, the display panel 120 increases not only the display size of the information in the display area 2a but also the difference between display brightness of the information and display brightness of the background when the distance acquisition module 310 determines that the distance between the display area 2a and the user's eyes increases in the display change processing.

For example, when the display brightness of the information, such as characters, is higher than the display brightness of the background in the display in the display area 2a, the display panel 120 increases the difference between the display brightness of the information and the display brightness of the background by changing the display color of the information so that the display brightness of the information is increased, or by changing the display color of the background so that the display brightness of the background is decreased.

When the display brightness of the information, such as characters, is lower than the display brightness of the background in the display in the display area 2a, the display panel 120 increases the difference between the display brightness of the information and the display brightness of the background by changing the display color of the information so that the display brightness of the information is decreased, or by changing the display color of the background so that the display brightness of the background is increased.

As described above, the display panel 120 increases not only the display size of the information in the display area 2a but also the difference between the display brightness of the information and the display brightness of the background when the distance acquisition module 310 determines that the distance between the electronic apparatus 1 and the user increases. As a result, when the middle-aged and elderly people slightly increase the distance between their eyes and the display area 2a after viewing the display in the display area 2a, the display size of the information in the display area 2a as well as the difference between the display brightness of the information and the display brightness of the background are increased. This allows the middle-aged and elderly people to more easily view the display in the display area 2a. Visibility of display of the electronic apparatus 1 is thus further improved.

<Fourth Modification>

When the user changes the distance between the display area 2a and the eyes by moving the electronic apparatus 1 close to or away from the eyes, acceleration of the electronic apparatus 1 changes.

In the fourth modification, the display panel 120 increases the display size of the information in the display area 2a when the acceleration of the electronic apparatus 1 changes while the line-of-sight detection module 320 detects the user's line of sight to the display area 2a. As a result, the display size of the information in the display area 2a is increased when the user changes the distance between the display area 2a and the eyes by moving the electronic apparatus 1.

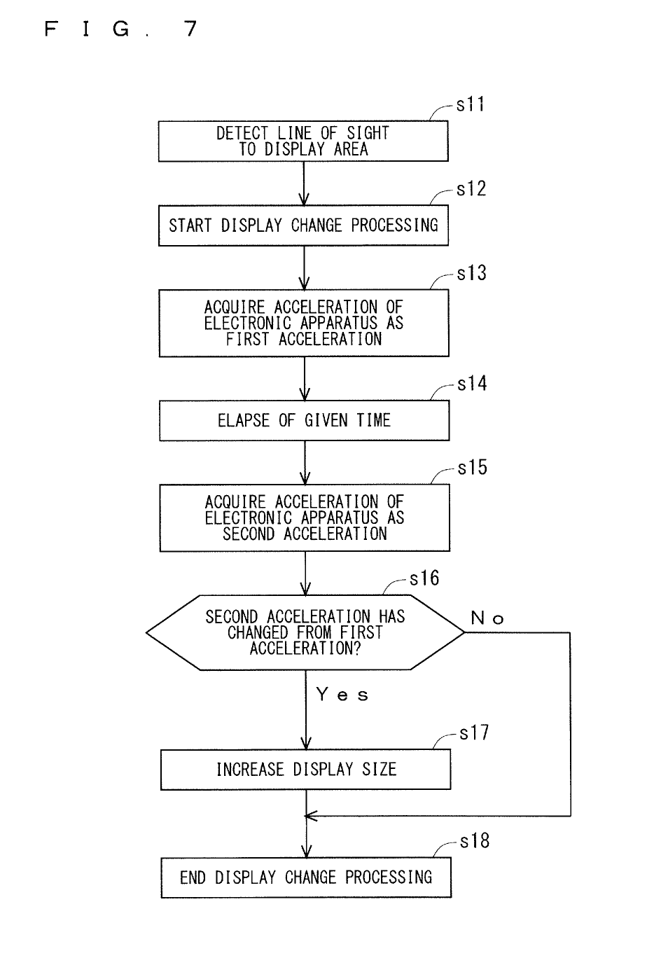

FIG. 6 illustrates some components of the electronic apparatus 1 according to the fourth modification. As illustrated in FIG. 6, the electronic apparatus 1 according to the fourth modification includes an acceleration acquisition module 330 that can acquire the acceleration of the electronic apparatus 1, in place of the distance acquisition module 310 in the electronic apparatus 1 illustrated in FIGS. 3 and 4 described above.

The acceleration acquisition module 330 includes an acceleration sensor 220 and a sensor control module 305 that can control the acceleration sensor 220. The sensor control module 305 is a functional block of the controller 100. The acceleration sensor 220 can detect the acceleration of the electronic apparatus 1 in the thickness direction of the apparatus case 4, for example. In other words, the acceleration sensor 220 can detect the acceleration of the electronic apparatus 1 in a direction perpendicular to the display area 2a provided on the front of the electronic apparatus 1. The acceleration sensor 220 detects the acceleration of the electronic apparatus 1 through control performed by the sensor control module 305, and outputs a detection signal indicating the detected acceleration to the sensor control module 305. The acceleration acquisition module 330 thus acquires the acceleration of the electronic apparatus 1.

FIG. 7 illustrates a flow chart showing operation of the electronic apparatus 1 according to the fourth modification. In the fourth modification, the line-of-sight detection module 320 performs the line-of-sight detection processing on a regular basis, e.g., every several hundred milliseconds, when the display in the display area 2a is ON.

As illustrated in FIG. 7, when a user who has not viewed the display in the display area 2a comes to view the display in the display area 2a, and thus the line-of-sight detection module 320 comes to detect a line of sight of the user to the display area 2a in a step s11, the electronic apparatus 1 according to the fourth modification starts the display change processing in a step s12.

Upon the start of the display change processing, the acceleration acquisition module 330 acquires, as first acceleration, the acceleration of the electronic apparatus 1 in a step s13. As a result, the acceleration of the electronic apparatus 1 immediately after the user comes to view the display in the display area 2a is acquired as the first acceleration.

When a given time (e.g., two seconds) has elapsed since the acquisition of the first acceleration (step s14), the acceleration acquisition module 330 acquires, as second acceleration, the acceleration of the electronic apparatus 1 in a step s15. As a result, the acceleration of the electronic apparatus 1 some time after the user comes to view the display in the display area 2a is acquired as the second acceleration.

Next, the sensor control module 305 of the acceleration acquisition module 330 determines whether the second acceleration has changed from the first acceleration in a step s16. Specifically, the sensor control module 305 determines whether the second acceleration has changed from the first acceleration by a predetermined value or more. The sensor control module 305 calculates the absolute value of the difference between the first acceleration and the second acceleration, and determines that the second acceleration has changed from the first acceleration by the predetermined value or more when the absolute value is equal to or more than the predetermined value. The sensor control module 305 determines that the second acceleration has not changed from the first acceleration by the predetermined value or more when the absolute value of the difference between the first acceleration and the second acceleration is less than the predetermined value.

When it is determined that the second acceleration has changed from the first acceleration by the predetermined value or more in the step s16, the display panel 120 increases the display size of the information, such as characters and icons, in the display area 2a through control performed by the display control module 304 in a step s17. When the step s17 is performed, the electronic apparatus 1 ends the display change processing in a step s18. When it is determined that the second acceleration has not changed from the first acceleration by the predetermined value or more in the step s16, the step s18 is performed without changing the display size of the information in the display area 2a to end the display change processing.

In the fourth modification, the display change processing as described above is performed only while the line-of-sight detection module 320 detects the line of sight of the user to the display area 2a. Therefore, the line-of-sight detection module 320 no longer detects the line of sight of the user to the display area 2a after the start of the display change processing (after the step s12) and before the end of the display change processing (before the step s18), the display change processing is forced to end. In this case, if the display size of the information in the display area 2a has been increased, the display panel 120 returns the display size of the information in the display area 2a to an original size. When the line-of-sight detection module 320 comes to detect the line of sight of the user to the display area 2a again (step s11), the step s12 is performed, and the electronic apparatus 1 thereafter operates in a similar manner.

When the line-of-sight detection module 320 no longer detects the line of sight of the user to the display area 2a after the step s18, the display panel 120 returns the display size of the information in the display area 2a to the original size. When the line-of-sight detection module 320 comes to detect the line of sight of the user to the display area 2a again (step s11), the step s12 is performed, and the electronic apparatus 1 thereafter operates in a similar manner.

As described above, in the electronic apparatus 1 according to the fourth modification, the display panel 120 increases the display size of the information in the display area 2a when the acceleration of the electronic apparatus 1 acquired by the acceleration acquisition module 330 changes while the line-of-sight detection module 320 detects the line of sight of the user to the display area 2a. The display size of the information in the display area 2a can thus be increased when the middle-aged and elderly people increase the distance between the display area 2a and their eyes by moving the electronic apparatus 1 so that the electronic apparatus 1 is moved away from their eyes. This allows the middle-aged and elderly people to easily view the display in the display region 2a. The display size of the information in the display area 2a can be increased when the people with myopia decrease the distance between the display area 2a and their eyes by moving the electronic apparatus 1 so that the electronic apparatus 1 is moved close to their eyes. This also allows the people with myopia to easily view the display in the display area 2a. Visibility of display of the electronic apparatus 1 is thus improved.

When the acceleration of the electronic apparatus 1 is acquired as in the fourth modification, the acceleration acquisition module 330 may repeatedly acquire the acceleration of the electronic apparatus 1 while the line-of-sight detection module 320 detects the line of sight of the user to the display area 2a, as in the above-mentioned first modification. In this case, after acquiring the acceleration of the electronic apparatus 1, the acceleration acquisition module 330 determines whether the acquired acceleration has changed from the acceleration of the electronic apparatus 1 acquired immediately before the acquisition. Specifically, the acceleration acquisition module 330 determines whether the acquired acceleration has changed from the acceleration acquired immediately before the acquisition by a predetermined value or more. When the acceleration acquisition module 330 determines that the acquired acceleration has changed from the acceleration acquired immediately before the acquisition by the predetermined value or more, the display panel 120 increases the display size of the information in the display area 2a. The display change processing then ends.

When the acceleration acquisition module 330 determines that the acquired acceleration has not changed from the acceleration acquired immediately before the acquisition by the predetermined value or more, the display panel 120 maintains the current display size without increasing the display size of the information in the display area 2a. In this case, the acceleration acquisition module 330 determines whether the acceleration acquired next has changed from the acceleration acquired immediately before the acquisition by the predetermined value or more without ending the display change processing. The electronic apparatus 1 then operates in a similar manner while the line-of-sight detection module 320 detects the user's line of sight to the display area 2a. While the line-of-sight detection module 320 detects the user's line of sight to the display area 2a, the acceleration acquisition module 330 may determine whether the acceleration acquired next has changed from the acceleration acquired immediately before the acquisition by the predetermined value or more without ending the display change processing even when the display panel 120 increases the display size of the information in the display area 2a. As a result, while the line-of-sight detection module 320 detects the user's line of sight to the display area 2a, the display size of the information in the display area 2a is increased each time the acceleration of the electronic apparatus 1 changes.

When the acceleration of the electronic apparatus 1 is acquired as in the fourth modification, the display change processing may be performed when the display screen in the display area 2a changes while the line-of-sight detection module 320 detects the user's line of sight to the display area 2a, as in the above-mentioned second modification. Therefore, when the user has difficulty viewing the display in the display area 2a due to the change of the display screen in the display area 2a, and changes the distance between the eyes and the display area 2a by moving the electronic apparatus 1, the display size of the information in the display area 2a can be increased. The display change processing may be performed each time the display screen in the display area 2a changes while the line-of-sight detection module 320 detects the user's line of sight to the display area 2a.

<Other Modifications>

Although a case where the disclosure of the present application is applied to a mobile phone has been described in the above-mentioned example, the disclosure of the present application can be applied to an electronic apparatus other than the mobile phone as long as the electronic apparatus has a display function.

While the electronic apparatus 1 has been described in detail as described above, the foregoing description is in all aspects illustrative and not restrictive. The above-mentioned various modifications can be applied in combination unless any contradiction occurs. It is understood that numerous modifications that have not been described can be devised without departing from the scope of the present disclosure.

1. An electronic apparatus comprising:
a display module configured to perform display in a display area;
a line-of-sight detection module configured to detect a line of sight of a user to the display area; and
a distance acquisition module configured to acquire a distance between the electronic apparatus and the user, wherein
the display module increases a display size of information in the display area when the distance changes while the line-of-sight detection module detects the line of sight.

2. The electronic apparatus according to claim 1, wherein
the display module increases not only the display size but also a difference between display brightness of the information and display brightness of a background when the distance increases while the line-of-sight detection module detects the line of sight.

3. An electronic apparatus comprising:
a display module configured to perform display in a display area;
a line-of-sight detection module configured to detect a line of sight of a user to the display area; and
an acceleration acquisition module configured to acquire acceleration of the electronic apparatus, wherein
the display module increases a display size of information in the display area when the acceleration changes while the line-of-sight detection module detects the line of sight.

4. The electronic apparatus according to claim 1, wherein
after increasing the display size, the display module returns the display size to an original size when the line-of-sight detection module no longer detects the line of sight.

5. The electronic apparatus according to claim 3, wherein
after increasing the display size, the display module returns the display size to an original size when the line-of-sight detection module no longer detects the line of sight.

6. The electronic apparatus according to claim 1, wherein
the distance acquisition module acquires the distance as a first distance when the line-of-sight detection module comes to detect the line of sight, and acquires the distance as a second distance when a given time has elapsed since the acquisition of the first distance, and
the display module increases the display size when the second distance has changed from the first distance.

7. The electronic apparatus according to claim 3, wherein
the acceleration acquisition module acquires the acceleration as first acceleration when the line-of-sight detection module comes to detect the line of sight, and acquires the acceleration as second acceleration when a given time has elapsed since the acquisition of the first acceleration, and
the display module increases the display size when the second acceleration has changed from the first acceleration.

8. The electronic apparatus according to claim 1, wherein
the distance acquisition module repeatedly acquires the distance while the line-of-sight detection module detects the line of sight, and
the display module increases the display size when the distance acquired by the distance acquisition module has changed from the distance acquired by the distance acquisition module immediately before the acquisition.

9. The electronic apparatus according to claim 3, wherein
the acceleration acquisition module repeatedly acquires the acceleration while the line-of-sight detection module detects the line of sight, and
the display module increases the display size when the acceleration acquired by the acceleration acquisition module has changed from the acceleration acquired by the acceleration acquisition module immediately before the acquisition.

10. The electronic apparatus according to claim 1, wherein
the distance acquisition module acquires the distance as a first distance when a display screen displayed in the display area changes while the line-of-sight detection module detects the line of sight, and acquires the distance as a second distance when a given time has elapsed since the acquisition of the first distance, and
the display module increases the display size when the second distance has changed from the first distance.

11. The electronic apparatus according to claim 3, wherein
the acceleration acquisition module acquires the acceleration as first acceleration when a display screen displayed in the display area changes while the line-of-sight detection module detects the line of sight, and acquires the acceleration as second acceleration when a given time has elapsed since the acquisition of the first acceleration, and
the display module increases the display size when the second acceleration has changed from the first acceleration.

12. A display control method for use in an electronic apparatus comprising a display area, the display control method comprising the steps of:
(a) detecting a line of sight of a user to the display area;
(b) acquiring a distance between the electronic apparatus and the user or acceleration of the electronic apparatus; and
(c) increasing a display size of information in the display area when the distance or the acceleration changes while the line of sight is detected.
